(19) United States
(12) Patent Application Publication
(10) Pub. No.: US 2010/0112326 A1
(43) Pub. Date: May 6, 2010

(54) COMPOUND MATERIAL MEMBER AND THE MANUFACTURING METHOD THEREOF

(75) Inventors: Chia-Ming TSAI, TAIPEI (TW); Yi-Chen TAO, TAIPEI (TW)

Correspondence Address: Muncy, Geissler, Olds & Lowe, PLLC, P.O. BOX 1364, FAIRFAX, VA, 22038-1364, US

(73) Assignee: PEGATRON CORPORATION, TAIPEI CITY (TW)

(21) Appl. No.: 12/607,573

(22) Filed: Oct. 28, 2009

(30) Foreign Application Priority Data
Nov. 3, 2008 (TW) 097142324

(51) Int. Cl. B32B 5/02; B29C 45/14; B29C 65/02

(52) U.S. Cl. 428/221; 264/257; 264/258

(57) ABSTRACT

A composite material member including a rubber element and a composite fiber element is manufactured by integrally combining rubber and composite fiber. A method for manufacturing the composite material member is also provided. In this method, the composite fiber element whether being thermosetting or not is disposed in a first mold of a mold. The composite fiber element is a structure of at least one fiber layer wrapped with resin. The first mold and a second mold of the mold are then closed. Finally, the cavity is filled with rubber. Different forming environments are provided according to whether the composite fiber element is thermosetting or not to form and fix the rubber element on the resin of the composite fiber element.

### CROSS-REFERENCE TO RELATED APPLICATIONS

This Non-provisional application claims priority under 35 U.S.C. §119(a) on Patent Application No(s). 097142324 filed in Taiwan, Republic of China on Nov. 13, 2008, the entire contents of which are hereby incorporated by reference.

### BACKGROUND OF THE INVENTION

1. Field of the Invention

The invention relates to a composite material member and a method for manufacturing the same and, more particularly, to a composite material member manufactured by integrally combining rubber and composite fiber and a method for manufacturing the same.

2. Description of the Related Art

In the past, casings of different kinds of electronic devices mainly have a design with a smooth appearance. In recent years, with development of the electronic device, certain casings have advanced touch, such as casings of notebook computers made of skin or bamboo to improve commodity value of the electronic devices and purchase desires of consumers.

Fiber reinforced plastic (FRP) is an insulating material generally used for a printed circuit board, and it belongs to a composite fiber material. The fiber structure of FRP can suffer greater tension, and the resin can suffer greater shearing force; and further, a surface of a casing may present special vision feeling as if a clothbound ancient book to greatly improve value and quality of an electronic device.

According to the aforementioned, if the composite fiber is used to form a casing, the casing can suffer greater external stress and is beneficial for a slim design of an electronic device, On the other hand, the composite fiber is also light to being beneficial for a light, slim, short, and small design of the electronic device. In addition, if the glass fiber is replaced with carbon fiber, the casing may further have an electromagnetic protection effect. Other composite fiber, such as Kevlar fiber, can also increase functionality of the casing of the electronic device according to characteristic of the material.

The characteristic of the composite fiber is different from that of plastic and an iron material (such as a metal material). When an element made of another material such as rubber is to be assembled to an inner side of the casing made of the plastic, the plastic casing can fix the element by wrapping the plastic around the element, or positioning ribs can be formed at the plastic casing to help assembling the element. If the casing is made of the iron material, a hole can be punched on the iron casing for assembling the element, or the element can be directly riveted to the iron casing. However, the above assembling method is not suitable for the casing made of the composite fiber.

In a practical application, a rubber element made of rubber should be fixed on an inner side of a casing to satisfy cushioning or positioning or other needs. However, if the rubber element is to be assembled to a surface of the casing made of the composite fiber, only glue or twin adhesive is used.

However, the method for assembling via the glue or the twin adhesive has a plurality of steps and higher costs and manpower; and further, since the rubber is elastic and is deformed easily, the strength and reliability is lower when the general glue or the twin adhesive is used. If the glue or the twin adhesive made of special silica gel is used, many negative effects on commercialized manufacture are happened as a result of the higher cost.

### BRIEF SUMMARY OF THE INVENTION

One objective of this invention is to provide a composite material member manufactured by integrally combining rubber and composite fiber and a method for manufacturing the same to improve the prior art.

One objective of the invention is to provide a composite material member manufactured by integrally combining fiber and rubber and a method for manufacturing the same. According to this method, a mold is used to manufacture the composite material member. The mold includes a first mold and a second mold having a cavity. The method includes the following steps.

First, a composite fiber element is disposed in the first mold. The composite fiber element may be thermosetting or not, and the composite fiber element is a structure of at least one fiber layer wrapped in resin. The first mold and the second mold are then closed. Finally, the cavity is filled with rubber. Different forming environments are provided according to whether the composite fiber element is thermosetting or not thus to form and fix a rubber element on the resin of the composite fiber element.

Another objective of the invention is to provide a composite material member. The composite material member includes a composite fiber element and a rubber element. The composite fiber element includes at least one fiber layer and resin wrapping the fiber layer. The rubber element is directly formed and fixed on the resin of the composite fiber element.

According to the composite material member and the method for manufacturing the same in this invention, the fiber and the rubber can be integrally combined to form the composite material member in cooperation with the mold and the forming steps. Thus, the composite material member has a surface with special touch, and the composite material member has powerful shearing resistance and tension resistance; and further, the composite material member is light and slim to being suitable for a light, slim, short, and small design of a commodity. Proper strength and reliability can be provided by combining the rubber and the composite fiber via the method in the invention. Combining processes can be further simplified to reduce consumption of accessory materials.

These and other features, aspects, and advantages of the present invention will become better understood with regard to the following description, appended claims, and accompanying drawings.

### BRIEF DESCRIPTION OF THE DRAWINGS

FIG. 1 is a partial exploded diagram showing a notebook computer according to one embodiment of the invention;

FIG. 2 is a side sectional schematic diagram showing a composite material member according to one embodiment of the invention;

FIG. 3 is a flow chart showing a method for manufacturing a composite material member according to one embodiment of the invention;

FIG. 4 is a schematic diagram showing a state corresponding to step S04 in FIG. 3 according to one embodiment of the invention;

FIG. 5 is a flow chart showing a first fixing mode according to one embodiment of the invention;

FIG. 6 is a flow chart showing a second fixing mode according to one embodiment of the invention; and

FIG. 7 is a schematic diagram showing a composite material member according to another embodiment of the invention.

### DETAILED DESCRIPTION OF THE INVENTION

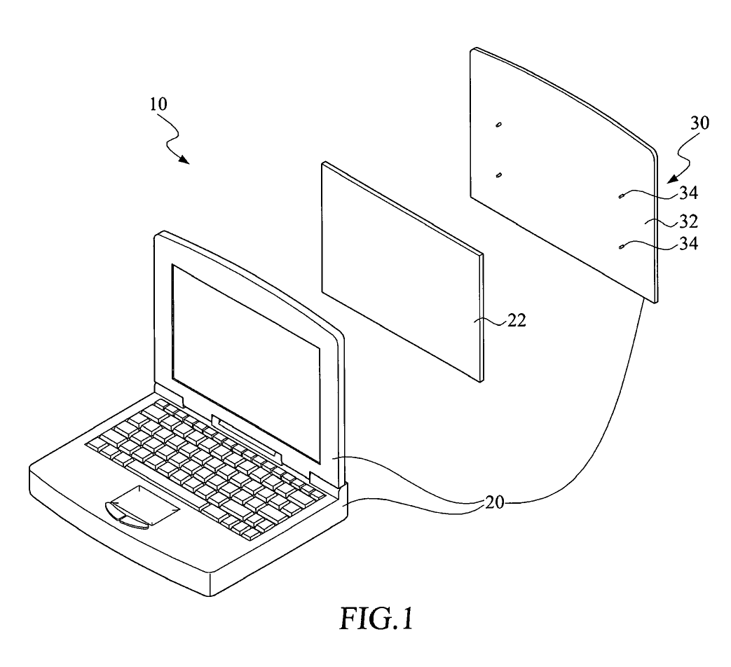

FIG. 1 is a partial exploded diagram showing a notebook computer 10 according to one embodiment of the invention. Please refer to FIG. 1. In one preferred embodiment of the invention, a composite material member 30 can be applied to a casing 20 of a commodity. The commodity may be a notebook computer 10, a liquid crystal display, an intelligent mobile phone, or other electronic commodities, and it may also be a packing box, furniture, or other non-electronic commodities. The composite material member 30 is suitable to be a main portion of the casing 20.

In FIG. 1, an upper cover with a liquid crystal panel 22 of the notebook computer 10 is taken for example to describe application of the composite material member 30. The composite material member 30 includes a composite fiber element 32 and a rubber element 34 which are integrally formed. One side of the composite fiber element 32 different from the rubber element 34 is suitable to be a surface of the casing 20. Thus, the appearance presents special texture and vision feeling as if a clothbound ancient book. The rubber element 34 is disposed in an inner side of the casing 20 to be used as a buffer of the liquid crystal panel 22 and the rubber element 34 also provides an effect upon shock absorbing and positioning.

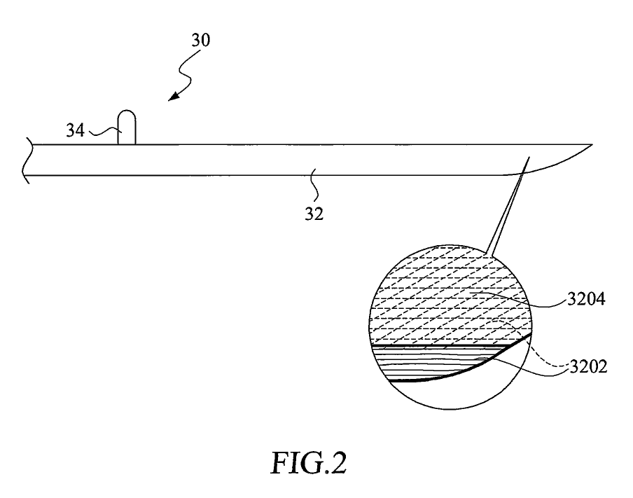

FIG. 2 is a side sectional schematic diagram showing the composite material member 30 according to one embodiment of the invention. Please refer to FIG. 2 the composite material member 30 includes a composite fiber element 32 and a rubber element 34. The composite fiber element 32 includes at least one fiber layer 3204 and resin 3202 wrapping the fiber layer 3204. In the enlarged section in FIG. 2, the composite fiber element 32 has six fiber layers 3204.

In generally, the fiber layer 3204 is a fabric. The fiber layer 3204 may be made of carbon fiber (CF), glass fiber, or Kevlar fiber and so on. The casing 20 may have an electromagnetic interference (EMI) prevention effect as the composite fiber element 32 is made of carbon fiber. The carbon fiber is further resistant to a high temperature above 1000° C. to simplify the manufacture.

In addition, the rubber element 34 is directly formed and fixed on the resin 3202. Thus, the appearance is that one rubber element 34 is fixed to a surface of the composite fiber element 32 to become an integral composite material member 30. If silicon rubber is used, a curing temperature is about in the range of 165-190° C. If neutral rubber is used, the curing temperature is about 150° C.

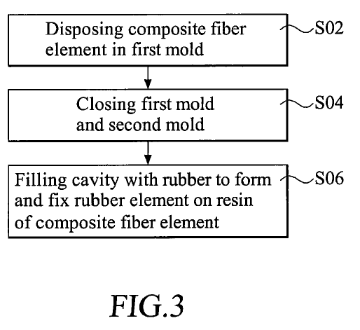

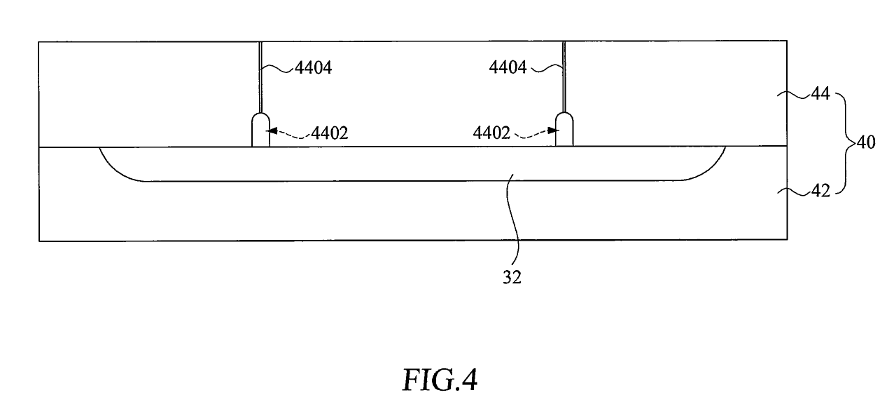

FIG. 3 is a flow chart showing a method for manufacturing a composite material member according to one embodiment of the invention. According to the method for manufacturing the composite material member 30, a mold 40 is used. The mold 40 includes a first mold 42 and a second mold 44, and the second mold 44 has a cavity 4402. The structure of the mold 40 and the composite material member 30 is described in detail in FIG. 4. The method includes the following steps.

Step S02: disposing a composite fiber element 32 in the first mold 42. The first mold 42 has a containing space for just containing the composite fiber element 32. The composite fiber element 32 is a structure of at least one fiber layer 3204 wrapped with resin 3202.

In this step, the composite fiber element 32 may be thermosetting or not. One surface of the composite fiber element 32 which is to be an outer surface of the casing 20 is located at the bottom surface of the containing space. The surface of the composite fiber element 32 which is exposed upward and used to combine the rubber element 34 is to be an inner surface of the casing 20.

Step S04: closing the first mold 42 and the second mold 44.

Step S06: filling the cavity 4402 with rubber to form and fix a rubber element 34 on the resin 3202 of the composite fiber element 32.

FIG. 4 is a schematic diagram showing a state corresponding to step S04 in FIG. 3 according to the embodiment of the invention. Please refer to FIG. 4 in cooperation with FIG. 3. The mold 40 is formed by stacking the second mold 44 and the first mold 42. The second mold 44 has the cavity 4402, and the cavity 4402 is communicated with outside via a runner 4404. The molten rubber flows from outside to the cavity 4402 via the runner 4404. The composite fiber element 32 is disposed in the first mold 42.

Furthermore, regarding the method for forming the rubber element 34, the rubber can be used to form the rubber element 34 through an injection mode wherein the step of closing the first mold 42 and the second mold 44 is to allow the opening of the cavity 4402 to face and to be attached to a surface of the composite fiber element 32, or through a hot-pressing mode. Besides, the step of filling the cavity 4402 with rubber can be adjusted to perform before the step of closing the first mold 42 and the second mold 44 according to the method of forming the rubber element 34.

The aforementioned formed composite material member 30 is a part of the casing 20 of a device, and the surface which is opposite to a surface of the composite fiber element 32 connecting the rubber element 34 is an external surface of the device. The special touch can improve commodity value of the device and purchase desires of consumers.

How to form and fix the rubber element 34 on the resin 3202 is described in detail hereinbelow. There are two fixing modes to allow the rubber element 34 to be directly formed and fixed on the resin 3202. In a first mode, an attached mode is used in a first forming environment. In a second mode, a fused mode is used in a second forming environment.

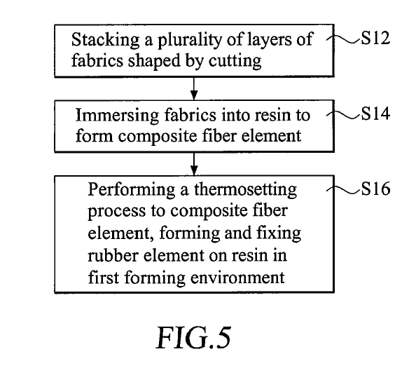

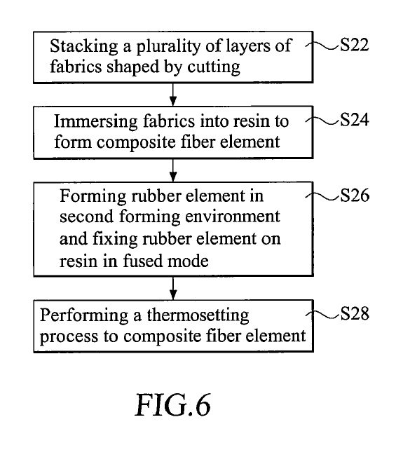

The first and second fixing modes are described in FIG. 5 and FIG. 6, respectively. FIG. 5 is a flow chart showing a first fixing mode according to one embodiment of the invention. The fixing mode in FIG. 5 further includes the following steps.

Step S12: stacking a plurality of layers of fabrics shaped by cutting according to the strength or the thickness of the casing 20 is needed.

Step S14: immersing the fabrics into resin 3202. The resin 3202 is used as adhesives between the respective layers of the fabric to form the composite fiber element 32; and further, the composite fiber element 32 is not thermosetting.

Step S16: performing a thermosetting process to the composite fiber element 32 and allowing the composite fiber element 32 to form the thermosetting composite fiber element 32.

According to the above, the rubber element 34 is formed in a first forming environment and the rubber element 34 is fixed on the resin 3202 of the thermosetting composite fiber element 32 in an attached mode.

When the first mode is used, since the composite fiber is thermosetting, only a thermal change of the rubber needs to be considered. That is, only the curing temperature of the rubber needs to be considered. Thus, the needed temperature of the first forming environment is estimated to be about between 0 and 200□, the pressure is about between 0 and 200 kgf, and the manufacturing time does not exceed 300 seconds. However, the needed manufacturing parameters are different according to different kinds of the rubber.

FIG. 6 is a flow chart showing a second fixing mode according to one embodiment of the invention. Please refer to FIG. 6. A fused mode in FIG. 6 includes the following steps.

Step S22: stacking a plurality of layers of fabrics shaped by cutting according to the strength or the thickness of the casing 20 is needed.

Step S24: immersing the fabrics into resin 3202. The resin 3202 is used as adhesives between the respective layers of the fabric to form the composite fiber element 32 which is not thermosetting.

Step S26: forming the rubber element 34 in a second forming environment and fixing the rubber element 34 on the resin 3202 of the composite fiber element 32 which is not thermosetting in the fused mode.

Step S28: performing a thermosetting process to allow the resin of the composite fiber element 32 which is not thermosetting and the rubber to be thermosetting. In this stage, the composite fiber element 32 can form the thermosetting composite fiber element 32.

When the second fixing mode is used, the composite material is not thermosetting. In this process, the thermal changes of the rubber and the resin 3202 need to be considered at the same time. Therefore, the needed temperature of the second forming environment is estimated to be about between 0 and 250□, the pressure is about between 0 and 500 kgf, and the manufacturing time does not exceed 90 minutes. However, the needed manufacturing parameters are also different according to different kinds of the rubber.

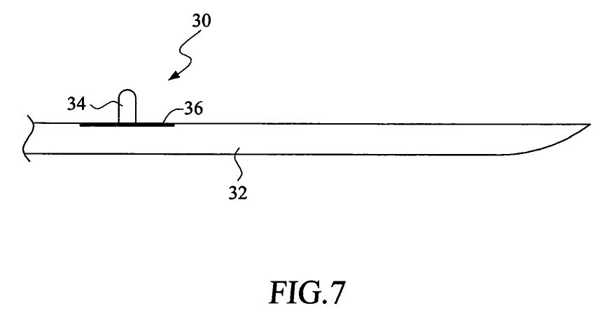

FIG. 7 is a schematic diagram showing a composite material member 30 according to another embodiment of the invention. For certain manufacture processes or products, to prevent the pressure and temperature at which the rubber element 34 is formed from damaging a surface of the resin 3202 when the rubber element 34 is fixed on a surface of the composite fiber element 32, the aforementioned method further includes the following steps after the composite fiber element 32 is disposed in the first mold 42 and before the rubber element 34 is formed and fixed.

A buffer material 36 is disposed at a surface of the resin 3202 where the rubber element 34 is to be formed and fixed. And then, the buffer material 36 can ease the heat and pressure generated when the rubber element 34 is formed, thus to prevent the surface of the resin 3202 of the formed composite fiber element 32 from being damaged seriously.

The buffer material 36 may be made of aluminum alloy, copper alloy, or Mylar.

According to the aforementioned, the fiber and the rubber can be integrally combined to form the composite material member 30 via the composite material member 30 and the method for manufacturing the composite material member 30 in the embodiment of the invention, in cooperation with the mold 40 and the forming steps. Thereby, the composite material member 30 has a surface with special touch, and the composite material member has powerful shearing resistance and tension resistance; and further, the composite material member 30 is light and slim to being suitable for a light, slim, short, and small design of a commodity. In the present invention, proper strength and reliability can be provided by combining the rubber and the composite fiber; moreover, combining processes can be simplified to reduce consumption of accessory materials.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for manufacturing a composite material member, the method performed in cooperation with a mold, the mold including a first mold and a second mold having a cavity, the method comprising the following steps of:
disposing a composite fiber element in the first mold, the composite fiber element being a structure of at least one fiber layer wrapped in resin;
closing the first mold and the second mold; and
filling the cavity with rubber to form and fix a rubber element on the resin of the composite fiber element.

2. The method according to claim 1, wherein the fiber layer is a fabric.

3. The method according to claim 2, further comprising the following steps of
stacking a plurality of layers of fabrics shaped by cutting; and
immersing the fabrics into the resin to form the composite fiber element.

4. The method according to claim 3, wherein before the step of disposing the composite fiber element in the first mold, the method further comprises the following step of:
performing a thermosetting process to the composite fiber element.

5. The method according to claim 4, wherein after performing a thermosetting process to the composite fiber element, the step of forming and fixing the rubber element is performed in a first forming environment to form the rubber element, and the rubber element is fixed on the resin of the composite fiber element in an attached mode.

6. The method according to claim 3, wherein the step of forming and fixing the rubber element further comprises the following steps of:
forming the rubber element in a second forming environment and fixing the rubber element to the resin of the composite fiber element in a fused mode; and
performing a thermosetting process to the composite fiber element.

7. The method according to claim 1, wherein in the step of forming and fixing the rubber element, the rubber element is formed through a hot-pressing mode.

8. The method according to claim 1, wherein the step of closing the first mold and the second mold is to allow the opening of the cavity to face the composite fiber element, and in the step of forming and fixing the rubber element, the rubber element is formed through an injection mode.

9. The method according to claim 1, wherein between the step of disposing the composite fiber element in the first mold and the step of forming and fixing the rubber element, the method further comprises the following step of:
disposing a buffer material on a surface of the resin of the composite fiber element where the rubber element is to be formed and fixed.

10. The method according to claim 9, wherein the buffer material is selected from the group consisting of aluminum foil, copper foil, a PC film, and Mylar.

11. The method according to claim 1, wherein the fiber layer is made of a material selected from the group consisting of carbon fiber, glass fiber, and Kevlar fiber.

12. A composite material member comprising:
a composite fiber element including at least one fiber layer and resin wrapping the fiber layer; and
a rubber element formed and fixed on the resin of the composite fiber element.

13. The composite material member according to claim 12, wherein the fiber layer is a fabric.

14. The composite material member according to claim 13, wherein the fiber layer is made of a material selected from the group consisting of carbon fiber, glass fiber, and Kevlar fiber.

15. The composite material member according to claim 12, wherein the rubber element is formed in a first forming environment and fixed in an attached mode.

16. The composite material member according to claim 12, wherein the rubber element is formed in a second forming environment and fixed in a fused mode.

17. The composite material member according to claim 12, wherein the rubber element is formed through a hot-pressing mode.

18. The composite material member according to claim 12, wherein the rubber element is formed through an injection mode.

19. The composite material member according to claim 12, wherein the composite material member further comprises a buffer material disposed between the composite fiber element and the rubber element.

20. The composite material member according to claim 19, wherein the cushioning material is selected from the group consisting of aluminum foil, copper foil, a PC film, and Mylar.
